(19) United States
(12) Patent Application Publication
(10) Pub. No.: US 2014/0066062 A1
(43) Pub. Date: Mar. 6, 2014

(54) SMART HOME NETWORK SYSTEM AND REGISTER CONTROLLER AND METHOD FOR REGISTERING HOME DEVICES

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: TE-SHENG CHEN, New Taipei (TW); XIAO-GUANG LI, Shenzhen (CN); KUAN-HONG HSIEH, New Taipei (TW); YUN XIAO, Shenzhen (CN); SHANG-HUI PI, Shenzhen (CN)

(73) Assignees: HON HAI PRECISION INDUSTRY CO., LTD., Shenzhen (CN); HONG FU JIN PRECISION INDUSTRY (ShenZhen) CO., LTD, Shenzhen (CN)

(21) Appl. No.: 13/951,478

(22) Filed: Jul. 26, 2013

(30) Foreign Application Priority Data
Aug. 31, 2012 (CN) 2012103179885

(51) Int. Cl. H04W 60/00

(52) U.S. Cl. CPC H04W 60/00
USPC 455/435.1

(57) ABSTRACT

A smart home network system includes a number of home devices, a smart gateway, and at least one register controller. The register controller generates and sends a registration request to the smart gateway. After receive the registration request, the smart gateway assigns a register region and a region code in a mapping list stored in the smart gateway. The register controller further generates and sends a registration code to the home devices in the area where the register controller is placed, in order to control the home devices to register their configuration information in the mapping list stored in the smart gateway. Therefore, the smart gateway is able to control each individual home device.

### BACKGROUND

1. Technical Field

The present disclosure relates to smart home technology, and particularly to a smart home network system, and a register controller and a method for registering home devices.

2. Description of Related Art

Today, smart home technology is becoming more and more popular. With this technology, devices in a house are connected to a smart home network system, so as to be controlled by the smart home network system.

When a new home device needs to be connected to the smart home network system, the device needs to be registered with the smart home network system. However, the existing registration process is complicated and inconvenient for the user.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic diagram of a smart home network system, according to a first embodiment. The system also illustrates a method for registering a number of home devices with a smart gateway.

FIG. 2 is a block diagram of the smart gateway of FIG. 1.

FIG. 3 is a block diagram of the home device of the system of FIG. 1.

FIG. 4 is a block diagram of a register controller of the system of FIG. 1.

FIG. 5 is a schematic diagram of a mapping list stored in the smart gateway of FIG. 2.

FIG. 6 is a schematic diagram of a control interface displayed on the smart gateway of FIG. 2 or on a control device.

FIG. 7 is another schematic diagram of a control interface displayed on the smart gateway of FIG. 2 or on a control device.

FIG. 8 is a flowchart illustrating a method for registering a number of home devices with a smart gateway, according to a second embodiment.

FIG. 9 is a flowchart illustrating a method for registering a number of home devices with a smart gateway, according to a third embodiment.

FIG. 10 is another schematic diagram of a mapping list stored in the smart gateway of FIG. 2.

FIG. 11 is a flowchart illustrating a method for registering a number of home devices with a smart gateway, according to a fourth embodiment.

### DETAILED DESCRIPTION

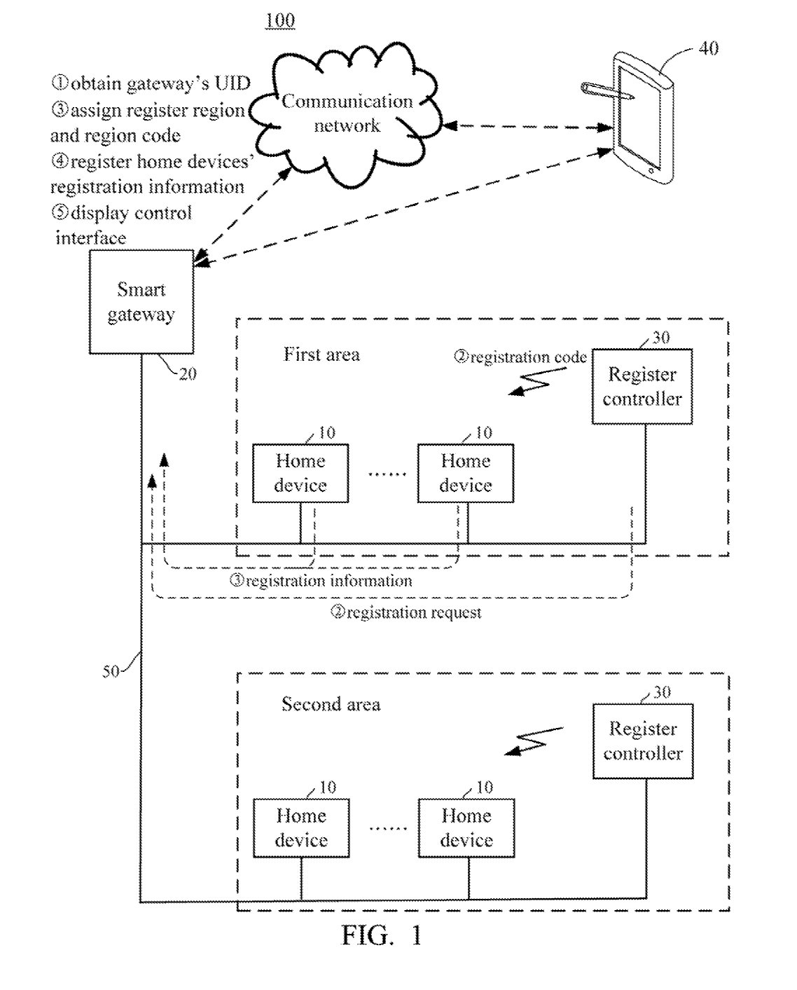

Referring to FIG. 1, a smart home network system 100 is provided. The system 100 includes a number of home devices 10 and a smart gateway 20. The smart gateway 20 is connected to a communication network. The home devices 10 may include, but are not limited to, a refrigerator, an air conditioner, an electric curtain, a lamp, and a smart socket.

In this embodiment, each device in the system 100 is provided with a unique identification (UID) code so that it can be uniquely identified by other devices.

Each home device 10 needs to register its configuration information with the smart gateway 20, when the home device 10 is connected to the system 100 for the first time or re-connected to the system 100, so as to allow the smart gateway 20 to control each individual home device 10.

In this embodiment, the system 100 further includes at least one register controller 30, each of which can be placed in a particular area (such as a room or a kitchen) of the house. In this embodiment, the register controller 30 can be an independent physical device, or be contained in a particular home device 10 in the area. Each register controller 30 controls a number of home devices 10 in the particular area where the register controller 30 is placed to register their configuration information with the smart gateway 20. In this embodiment, the register controller 30 generates and sends a registration request to the smart gateway 20 in order to start a registration process for registering the home devices 10 in the particular area. The register controller 30 further generates and sends a registration code to the home devices 10, in order to control the home devices 10 to register their configuration information with the smart gateway 20.

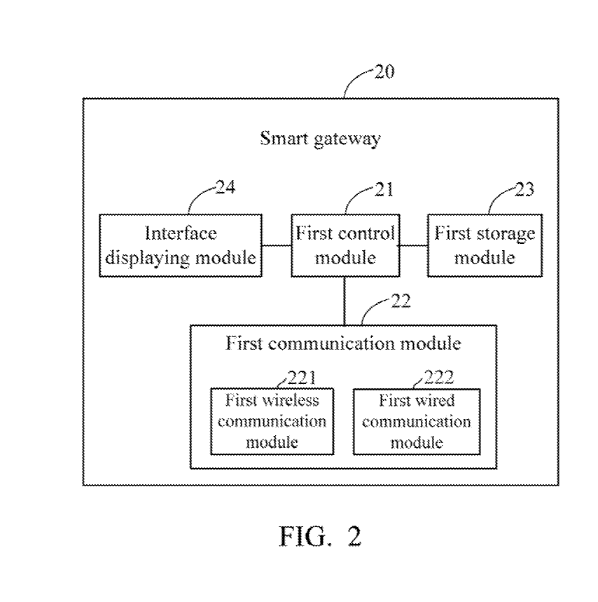

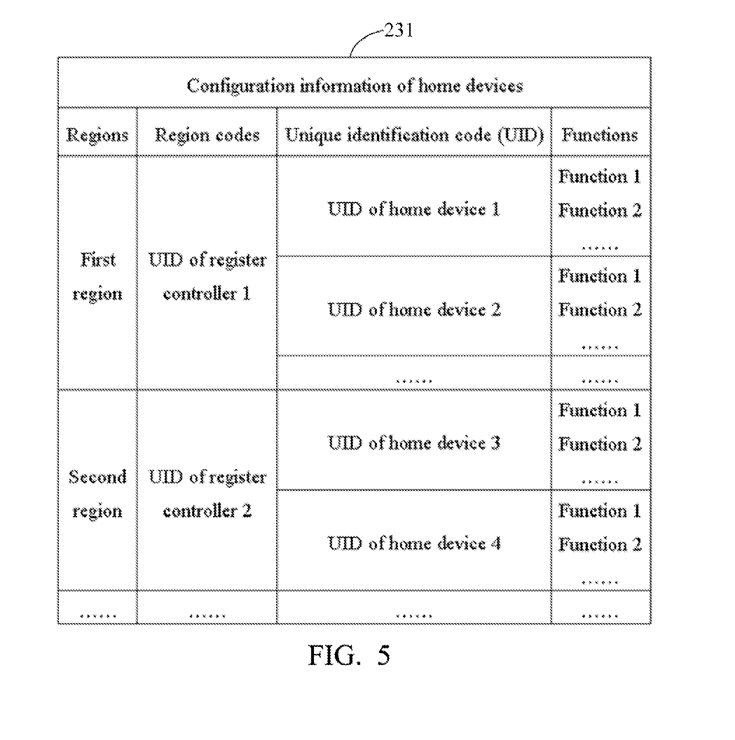

Referring to FIG. 2, in this embodiment, the smart gateway 20 includes a first control module 21, a first communication module 22, a first storage module 23, and an interface displaying module 24. The first storage module 23 stores the UID code of the smart gateway 20, and a mapping list 231 (as shown in FIG. 5). The mapping list 231 records the configuration information of each home device 10 in the system 100. In this embodiment, the configuration information contains region codes representing areas where the home devices 10 are placed, and the UID codes and functions of each home device 10.

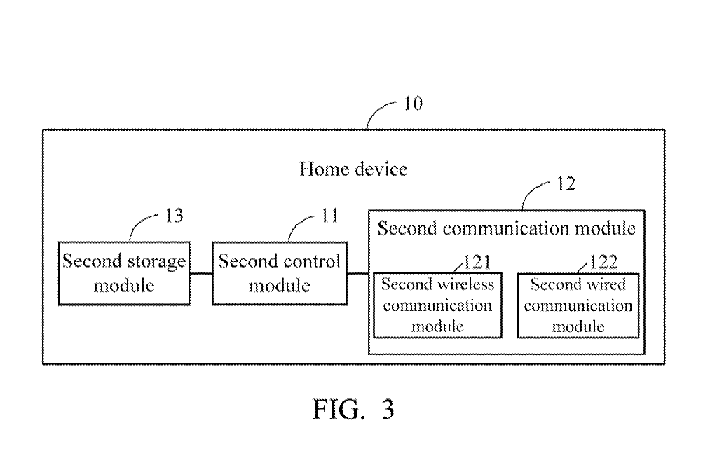

Referring to FIG. 3, each home device 10 includes a second control module 11, a second communication module 12, and a second storage module 13. The second storage module 13 stores the UID code of the home device 10.

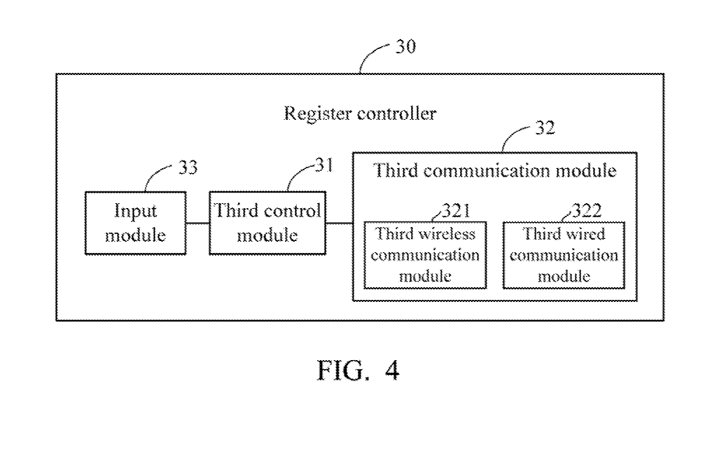

Referring to FIG. 4, the register controller 30 includes a third control module 31, a third communication module 32, and an input module 33. The input module 33 is a button or a touch screen on the register controller 30 configured to allow a user to input information.

Functions of the above modules of the home device 10, the smart gateway 20, and the register controller 30 will be described in detail as shown in the following.

In this embodiment, the smart gateway 20 communicates with the home devices 10 and the register controller 30 via wireless communication technology.

Referring again to FIGS. 2-4, in this embodiment, the first communication module 22 includes a first wireless communication module 221, the second communication module 12 includes a second wireless communication module 121, and the third communication module 32 includes a third wireless communication module 321. The first wireless communication module 221, the second wireless communication module 121, and the third wireless communication module 321 all emit and receive near field wireless signals. The near field wireless signals may include, but are not limited to, infrared, Bluetooth, Z-wave, NFC, ZigBee, and WIFI signals. In all embodiments of this present disclosure, each of the first wireless communication module 221, the second wireless communication module 121, and the third wireless communication module 321 is an infrared signal transceiver.

The smart gateway 20 also communicates with the home devices 10 and the register controller 30 via wired communication technology. In this embodiment, the first communication module 22 further includes a first wired communication module 222, the second communication module 12 further includes a second wired communication module 122, and the third communication module 32 further includes a third wired communication module 322. The first wired communication module 222, the second wired communication module 122, and the third wired communication module 322 communicate with each other via Power Line Communication (PLC), Optical Fiber

Power Line Communication (OPLC), Internet communication, coaxial cable communication, telephone line communication, or other communication technologies.

In all embodiments of this present disclosure, the smart gateway 20 is connected to each home device 10 and the register controller 30 via power lines 50, and the first wired communication module 222, the second wired communication module 122, and the third wired communication module 322 communicate with each other via PLC or OPLC technologies. Each of the first wired communication module 222, the second wired communication module 122, and the third wired communication module 322 is a modulation module, which extracts data from or injects data to the power lines 50.

Therefore, the power lines 50 not only supply power to the devices, but also serve as a carrier for data transmission.

Specifically, the first wired communication module 222, the second wired communication module 122, and the third wired communication module 322 receive incoming data packets (PLC or OPLC data packets) from the power lines 50, and demodulate the data packets and convert network protocols as required. The first wired communication module 222, the second wired communication module 122, and the third wired communication module 322 also modulate to-be-transmitted data of the device and convert network protocols, and then send the to-be transmitted data to other devices via the power lines 50. With such a structure, the home devices 10 and the register controllers 30 can be connected to the system 100 by being directly plugged into existing power sockets in existing wiring of a house.

Referring again to FIG. 1, a method for registering a number of home devices 10 with a smart gateway 20 is illustrated, according to a first embodiment. In the first embodiment, the at least one register controller 30 includes a number of register controller 30. Each register controller 30 is placed in a particular area in the house.

In step 1, the register controller 30 obtains the UID code of the smart gateway 20 via the third communication module 32.

In the first embodiment, the gateway 20 initiates a registration process, and the first control module 21 controls the first wireless communication module 221 to send out the UID code of the gateway 20. The third wireless communication module 321 of the register controller 30 receives the UID code of the gateway 20. Because the wireless technology employed is infrared transmission, the register controller 30 is carried to the smart gateway 20, such that the register controller 30 is within range of the infrared signal.

In step 2, the register controller 30 is carried to a first area and is connected to the system 100. The third control module 31 of the register controller 30 generates the registration request and the registration code in response to user's input in the input module 33. The third control module 31 controls the third communication module 32 to send the registration request to the smart gateway 20, and send the registration code to all of the home devices 10 in the first area.

In the first embodiment, the third control module 31 controls the third wired communication module 322 to send the registration request to the smart gateway 20 via the power lines 50, and controls the third wireless communication module 321 to send the registration code wirelessly to all the home devices 10 placed in the first area. The registration request and the registration code contain the UID code of the smart gateway 20 and the UID code of the register controller 30.

In step 3, when the first communication module 22 of the smart gateway 20 received the registration request from the register controller 30, the first control module 21 assigns a register region and a region code in the mapping list 231 (as shown in FIG. 5) for the home devices 10 in the first area. In the first embodiment, the first control module 21 assigns the UID code of the register controller 30 that sent out the registration request as the region code for the home devices 10 in the first area, and records the region code in the corresponding register region in the mapping list 231.

At the same time, when the home devices 10 in the first area receive the registration code from the register controller 30 via their second communication modules 12, the second control modules 11 control the second communication modules 12 to send their registration information to the smart gateway 20.

In the first embodiment, the home devices 10 receive the registration code from the register controller 30 via their second wireless communication modules 121 and send their registration information to the smart gateway 20 via their second wired communication modules 122 and the power lines 50. The registration information contains the UID code of the smart gateway 20, the UID code of the register controller 30, and the configuration information of the home devices 10. The configuration information contains the UID code and functions of the home devices 10.

In step 4, when the first communication module 22 of the smart gateway 20 receives the registration information from the home devices 10, the first control module 21 registers the configuration information of the home devices 10 in the corresponding register region in the mapping list 231. Therefore, the configuration information of the home devices 10 placed in the same area is registered in the same register region in the mapping list 231.

If a new home device 10 is added to a registered area (that is, the registration information of the home devices in the area have been registered in the mapping list 231 of the smart gateway 20) and needs to be registered with the smart gateway 20, the process repeats steps 2-4 again.

It should be noted that, due to the UID code of each home device 10 being unique, the registration information of each home device 10 will only be registered once in the mapping list 231. If a home device 10 is moved to a new area, the registration information of the home device 10 registered in an original register region in the mapping list 231 will be deleted, and the registration information will be registered in a new register region in the mapping list 231.

The registration process for other home devices 10 placed in other areas is similar to steps 1-4.

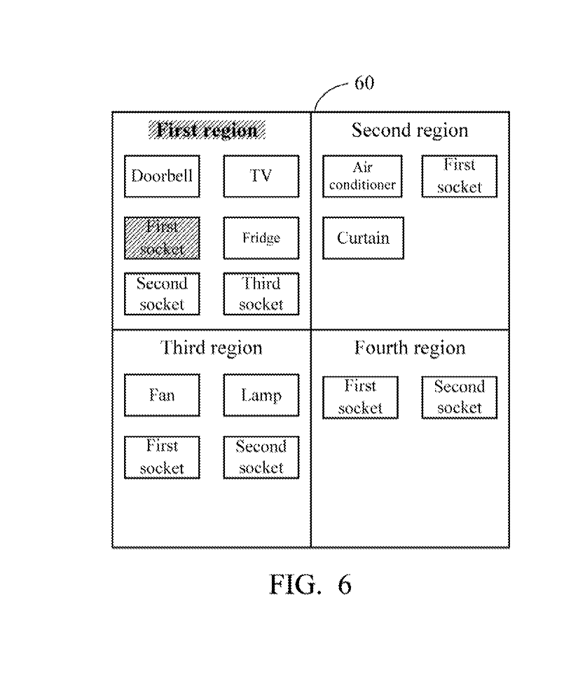

In step 5, the interface displaying module 24 of the smart gateway 20 displays a control interface 60 (as shown in FIG. 6), according to the mapping list 231. In the first embodiment, the control interface 60 includes a number of regions corresponding to the areas in the house. Each region includes a number of icons corresponding to the home devices 10 placed in a corresponding area in the house, and each icon includes corresponding control options to control the corresponding home device 10.

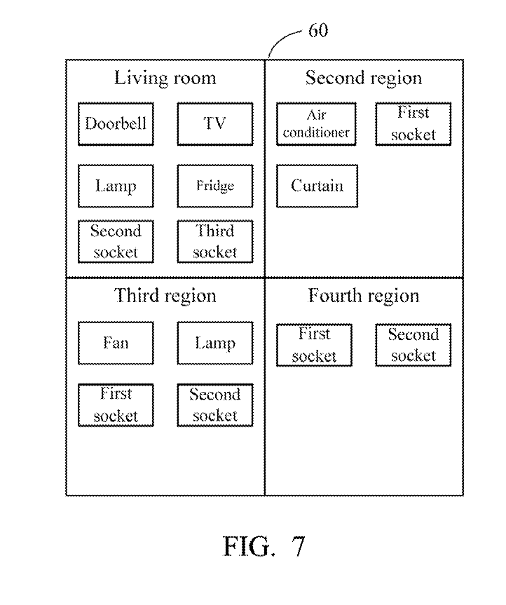

In the first embodiment, the interface displaying module 24 displays a schematic diagram of the regions according to the region codes of the mapping list 231, displays the icons of the home devices 10 in the corresponding regions according to their corresponding UID codes and the region codes registered in the mapping list 231, and displays the control options for the corresponding icons according to the functions of the corresponding home devices 10 registered in the mapping list 231. The user can rename the regions or the icons. For example, as shown in FIG. 7, the user can rename the first region as “living room” and a first socket as “lamp.”

Such that, the registration process of the home devices 10 with the smart gateway 20 in the first embodiment is completed.

Referring again to FIG. 1, the system 100 further includes a control device 40. The control device 40 may be selected from a group consisting of a smart phone and a tablet computer. The control device 40 communicates with the smart gateway 20 via wired communication technology or wireless communication technologies. The control device 40 displays the control interface 60 according to the mapping list 231 stored in the smart gateway 20, such that the user can control each of the home devices 10 remotely.

In other embodiments, the above registration process further includes processes for safety certification:

In the above step 1, the smart gateway 20 further sends a password to the register controller 30. The password is used as a registration password for registering the home devices 10 with the smart gateway 20. The password can be the UID code of the smart gateway 20, for example.

In the above step 2, the register controller 30 encrypts the registration request with the password before sending the registration request to the smart gateway 20. In this embodiment, the registration code that the register controller 30 sends to the home devices 10 further contains the password.

In the above step 3, the home devices 10 encrypt the registration information with the password before sending the registration information to the smart gateway 20.

When the smart gateway 20 receives the encrypted registration request from the register controller 30, or the encrypted registration information from the home devices 10, the smart gateway 20 decrypts the encrypted registration request or the encrypted registration information with the password.

Therefore, the above information of the system 100 transmitted through the power lines 50 will not be obtained by other devices in other home network systems in other houses, in order to ensure information security.

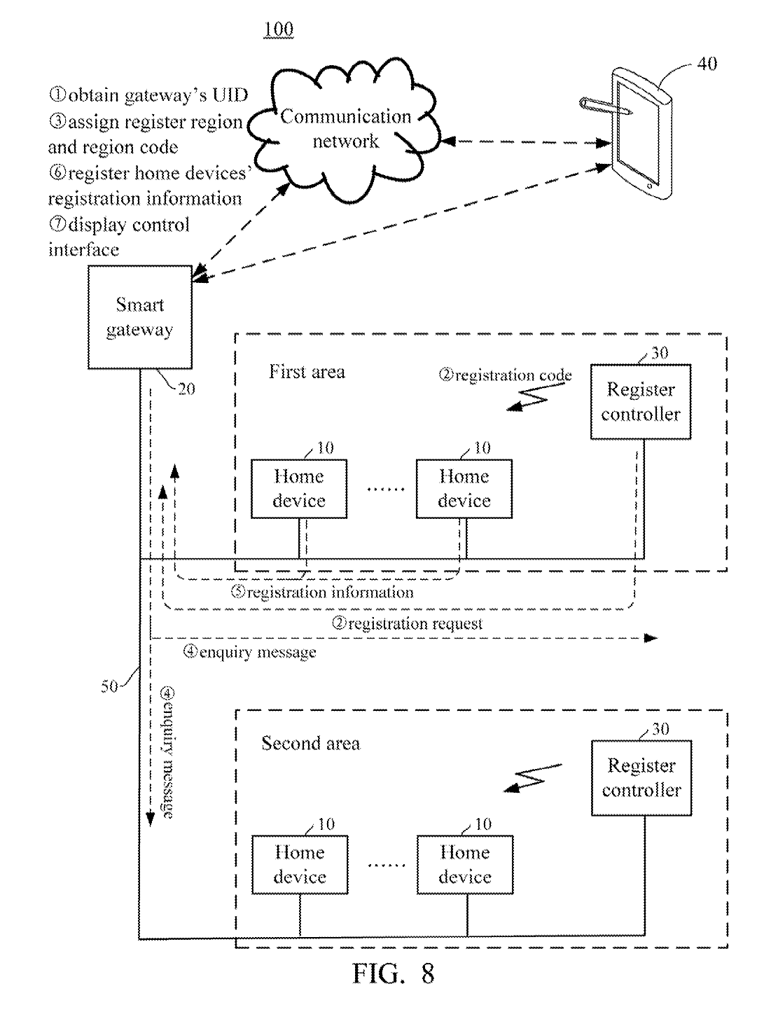

Referring to FIG. 8, a method for registering a number of home devices 10 with a smart gateway 20 is illustrated, according to a second embodiment.

The second embodiment is similar to the first embodiment, except that after the first control module 21 assigns a register region and a region code in the mapping list 231 for the home devices 10 (step 3), the first control module 21 generates an enquiry message that contains the region code, and controls the first wired communication module 222 to send the enquiry message to all home devices 10 in the system 100 via the power lines 50 (step 4). The enquiry message is a signal that used to distinguish the home devices 10 which have received the registration code sent by the register controller 30, that is, to distinguish which home devices 10 are in the same area as the register controller 30 that sent out the registration request. When the home devices 10 received the enquiry message from the smart gateway 20 via their second wired communication modules 122 and received the registration code from the registration controller 30 via their second wireless communication modules 121, the second control modules 11 of the home devices 10 determine whether or not the region code contained in the received enquiry message is the same as the UID code of the register controller 30 contained in the registration code. If the region code matches the UID code of the register controller 30, the second control modules 11 of the home devices 10 control the second wired communication modules 122 to send their registration information to the smart gateway 20 via the power lines 50 (step 5).

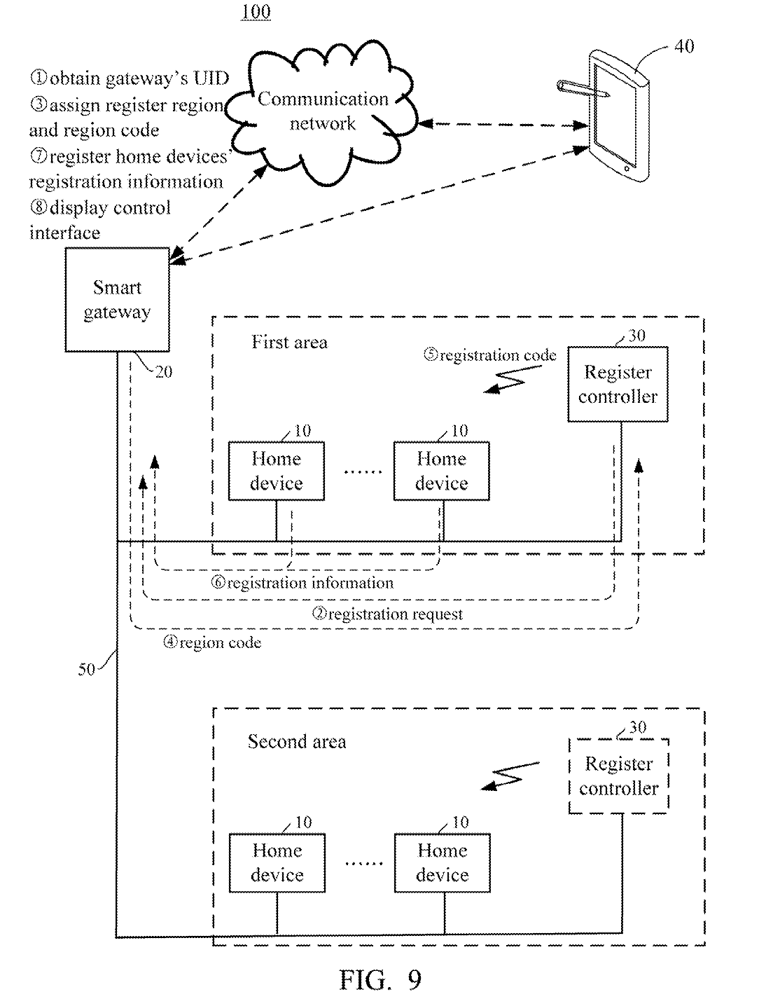

Referring to FIG. 9, a method for registering a number of home devices 10 with a smart gateway 20 is illustrated, according to a third embodiment.

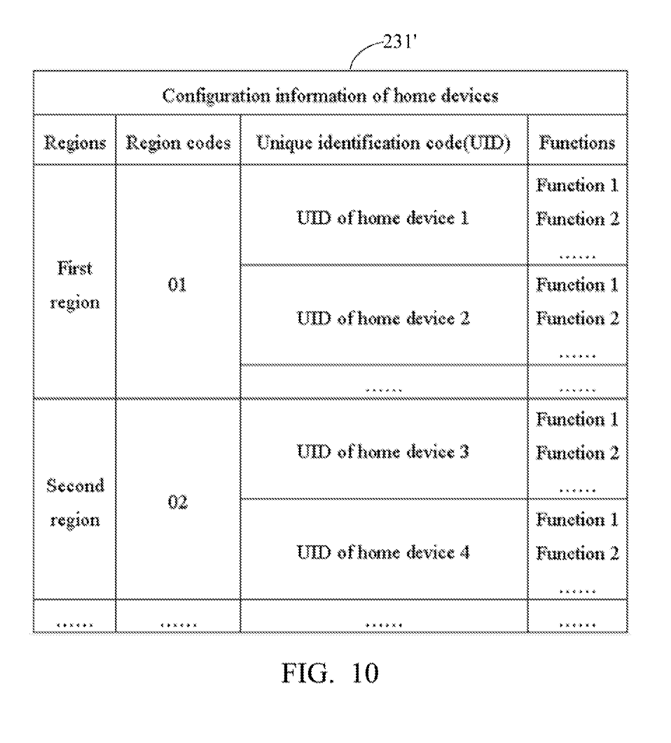

The third embodiment is similar to the first embodiment, except that the third embodiment only has one register controller 30. The register controller 30 can be moved to different areas of the house at different times. When the user controls the register controller 30 in a first area to generate a registration request, the third wired communication module 322 sends the registration request to the smart gateway 20 via the power lines 50 (step 2). When the first communication module 22 of the smart gateway 20 receives the registration request from the register controller 30, the first control module 21 assigns a register region and a region code in the mapping list 231′ (as shown in FIG. 10) for the home devices 10 in the first area (step 3). In the third embodiment, the first control module 21 assigns the region code according to a number or an order of the received registration requests, for example. Then, the first wired communication module 222 sends the region code back to the register controller 30 that sent out the registration request via the power lines 50 (step 4). When the register controller 30 received the region code via the third wired communication module 322, the third control module 31 generates the registration code that contains the region code and the UID code of the smart gateway 20, and the third wireless communication module 321 sends the registration code to the home devices 10 in the first area (step 5). Then the home devices 10 send their registration information to the smart gateway 20 as previously described (step 6).

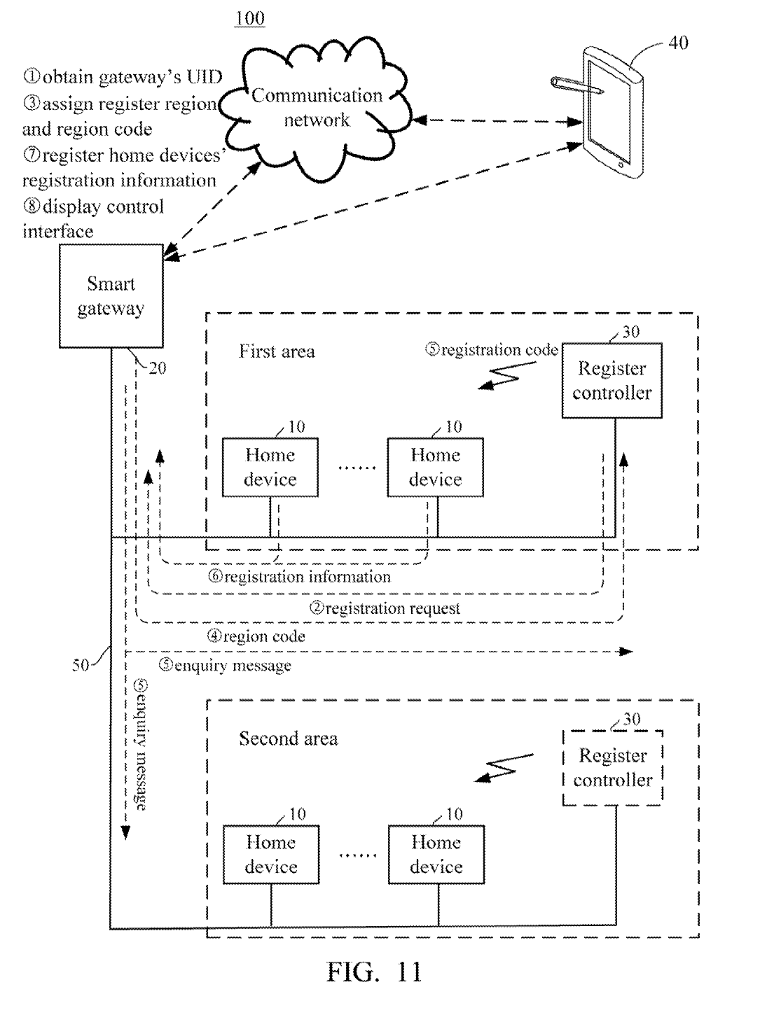

Referring to FIG. 11, a method for registering a number of home devices 10 with a smart gateway 20 is illustrated, according to a fourth embodiment.

The fourth embodiment is similar to the third embodiment, except that the fourth embodiment utilizes an enquiry message like the second embodiment. However, the region code is assigned according to a number or an order of the received registration requests, for example, not the UID code of the register controller 30. When the register controller 30 received the region code from the smart gateway 20, the controller 30 sends the registration code to the home devices 10 in the first area (step 5). When the home devices 10 received the enquiry message from the smart gateway 20 via the power lines 50 and received the registration code from the registration controller 30, the home devices 10 send their registration information to the smart gateway 20 if the region code in the received enquiry message matches the region code contained in the registration code (step 6).

Moreover, it is to be understood that the disclosure may be embodied in other forms without departing from the spirit thereof. Thus, the present examples and embodiments are to be considered in all respects as illustrative and not restrictive, and the disclosure is not to be limited to the details given herein.

What is claimed is:

1. A register controller applied to a smart home network system, the system comprising a number of home devices and a smart gateway, the register controller comprising:
a communication module configured to obtain a UID code of the smart gateway and a region code assigned by the smart gateway; and
a control module and an input module, the control module configured to generate a registration request in response to user's input in the input module, and control the communication module to send the registration request to the smart gateway; the control module further configured to generate a registration code, and control the communication module to send the registration code to the home devices in a particular area where the register controller is placed, wherein the registration code contains the UID code of the smart gateway and the region code.

2. The register controller as described in claim 1, wherein the communication module comprises a wireless communication module, the wireless communication module emits and receives near field wireless signals, so as to enable the register controller to communicate with the smart gateway via wireless communication technology, wherein the near field wireless signal is selected from a group consisting of infrared, Bluetooth, Z-wave, NFC, ZigBee, and WIFI signals.

3. The register controller as described in claim 1, wherein the communication module comprises a wired communication module, the wired communication module emits and receives wired signals, so as to enable the register controller to communicate with the smart gateway via wired communication technology, wherein the wired communication technology is selected from a group consisting of PLC, OPLC, Internet communication, coaxial cable communication, and telephone line communication technologies.

4. A smart home network system comprising a number of home devices, a smart gateway and at least one register controller,
the smart gateway comprising:
a first storage module storing a UID code of the smart gateway and a mapping list;
a first communication module configured to send the UID code of the smart gateway to the at least one register controller, and receive registration requests from the at least one register controller and registration information from the home devices, wherein the registration request comprises the UID codes of the smart gateway and the register controller, the registration information comprises the UID code of the smart gateway, a region code, and the configuration information of the home device; and
a first control module configured to assign a register region and the region code in the mapping list for the home devices placed in a particular area where the register controller is placed, and controls the first communication module to send the region code to the register controller; the first control module further configured to register the configuration information of the home devices in the corresponding register region in the mapping list, according to the region code contained in the registration information;
each of the at least one register controller comprising:
a third communication module configured to obtain the UID code of the smart gateway and the region code assigned by the smart gateway; and
a third control module and an input module, the third control module configured to generate the registration request in response to user's input in the input module, and control the communication module to send the registration request to the smart gateway; the control module further configured to generate a registration code, and control the communication module to send the registration code to the home devices in the particular area where the register controller is placed, wherein the registration code contains the UID code of the smart gateway and the region code; and
each of the home devices configured for receiving the registration code from the register controller, and sending its registration information to the smart gateway.

5. The system as described in claim 4, wherein the at least one register controller comprises a plurality of register controllers, the first control module of the smart gateway assigns the UID code of the register controller that sent out the registration request as the region code for the home devices placed in the particular area where the register controller is placed.

6. The system as described in claim 4, wherein the at least one register controller comprises a register controllers, the first control module of the smart gateway assigns the region code according to a number and an order of the received registration requests.

7. The system as described in claim 4, wherein the smart gateway further comprises an interface displaying module, the interface displaying module is configured to display a control interface according to the mapping list, wherein the control interface comprises a plurality of regions, each region comprises a number of icons corresponding to the home devices placed in a corresponding area, and each icon comprises corresponding control options to control the corresponding home device.

8. The system as described in claim 4, further comprising a control device, wherein the control device communicates with the smart gateway, and displays a control interface according to the mapping list stored in the smart gateway, wherein the control interface comprises a plurality of regions, each region contains a number of icons corresponding to the home devices placed in a corresponding area, and each icon comprises corresponding control options to control the corresponding home device.

9. The system as described in claim 4, wherein each of the first communication module, the second communication module, and the third communication module comprises a wireless communication module, which emit and receive near field wireless signals, so as to enable the smart gateway to communicate with the home devices and the register controller via wireless communication technology, wherein the near field wireless signal is selected from a group consisting of infrared, Bluetooth, Z-wave, NFC, ZigBee, and WIFI signals.

10. The system as described in claim 4, wherein each of the first communication module, the second communication module, and the third communication module comprises a wired communication module, which emit and receive wired signals, so as to enable the smart gateway to communicate with the home devices and the register controller via wired communication technology, wherein the wired communication technology is selected from a group consisting of PLC, OPLC, Internet communication, coaxial cable communication, and telephone line communication technologies.

11. The system as described in claim 4, wherein the smart gateway is connected to each home device and the register controller via power lines, and communicates with each home device and the register controller via PLC or OPLC technologies; each of the first communication module, the second communication module, and the third communication module comprises a wired communication module, which is a modulation module, and is configured to extract data from or inject data to the power lines.

12. A method applied to a smart home network system, for registering a number of home devices with a smart gateway, the system further comprising at least one register controller, the method comprising:
obtaining an UID code of the smart gateway using the register controller;
generating a registration request in response to user's operation using the register controller when the register controller is carried to a particular area, wherein the registration request contains the UID codes of the smart gateway and the register controller;
receiving the registration request from the register controller, and assigning a register region and a region code in a mapping list stored in the smart gateway for the home devices placed in the particular area, and sending the region code back to the register controller that sent out the registration request using the smart gateway;
receiving the region code, and generating and sending a registration code to all of the home devices in the particular area using the register controller, wherein the registration code contains the UID code of the smart gateway and the region code;
receiving the registration code from the register controller, and sending their registration information to the smart gateway using the home devices in the particular area, wherein the registration information comprises the UID code of the smart gateway,
the region code and their configuration information;
receiving the registration information from the home devices, and registering the registration information in the corresponding register region in the mapping list using the smart gateway, according to the region code contained in the registration information.

13. The method as described in claim 12, wherein after the step of assigning the register region and the region code in the mapping list for the home devices placed in the particular area using the smart gateway, the method further comprises:
generating an enquiry message that contains the region code, and sending the enquiry message to all home devices in the system using the smart gateway.

14. The method as described in claim 13, wherein after the home devices receive the enquiry message from the smart gateway and the registration code from the registration controller, the home devices send their registration information to the smart gateway if the region code in the received enquiry message matches the region code contained in the registration code.

15. The method as described in claim 14, wherein the configuration information comprises the UID code and functions of the home devices.

16. The method as described in claim 15, further comprising:
displaying a control interface using the smart gateway, according to the mapping list, wherein the smart gateway displays a schematic diagram of a number of regions according to the region codes in the mapping list, displays a number of icons in corresponding regions according to the UID code of the home devices and the region codes registered in the mapping list, and displays the control options for the corresponding icons according to the functions of the corresponding home device registered in the mapping list.
